(19) United States
(12) Patent Application Publication
(10) Pub. No.: US 2001/0050929 A1
(43) Pub. Date: Dec. 13, 2001

(54) Method and configuration for setting the frequency of a transmitting laser

(76) Inventors: Werner Dietrich, Wien (AT); Martin Schreiblehner, Wien (AT)

Correspondence Address: LERNER AND GREENBERG, P. A., POST OFFICE BOX 2480, HOLLYWOOD, FL, 33022-2480, US

(21) Appl. No.: 09/752,921

(22) Filed: Jan. 2, 2001

(30) Foreign Application Priority Data
Dec. 30, 1999 (DE) 199 63 803.9

(51) Int. Cl. H01S 3/10

(52) U.S. Cl. 372/20

(57) ABSTRACT

A configuration for setting the frequency of a transmitting laser in an optical transmission system having a transmitting end and a receiving end, includes, a first controlling system, a power meter, a service channel, and a controlling system. The first controlling system provided at the transmitting end varies experimentally a frequency of the transmitting laser. The power meter provided at the receiving end measuring a power of the received signal. The service channel connects to said power meter. The controlling system at the receiving end receives measured values from the service channel. The controlling system measures the received measured values and varies the frequency of the transmitting laser to maximize the received power.

### BACKGROUND OF THE INVENTION

1. Field of the Invention

The invention relates to a method and a configuration for setting the frequency of a transmitting laser in an optical transmission system.

In optical transmission systems, the transmitting lasers undergo a frequency drift as a function of the ambient temperature and of the service life. The passbands of the filtering elements such as optical multiplexers and demultiplexers likewise undergo a drift that is a function of temperature and time. These effects are seen in a worsening of the transmission quality, particularly in the case of wavelength diversity multiplex systems (WDM). With a rising number of transmission channels and with the associated smaller frequency spacings between the channels (100 GHz, 50 GHz), the technically determined drifts and tolerances of transmitter frequency and filter pass curves become so large that the transmitted signals can drift to the edge of the pass curves.

To date, the transmitter frequency has been kept constant via a closed loop with the aid of calibrated filters. This method is described in “Optical Networks” by R. Ramaswami, K. N. Sirarajan, 1988, Morgan Kaufmann Publishers, pages 248-249, in particular 249, first paragraph. The frequency drift of the transmission link and the receiver has not so far been taken into account.

### SUMMARY OF THE INVENTION

It is accordingly an object of the invention to provide a method and configuration for setting the frequency of a transmitting laser that overcomes the above-mentioned disadvantages of the prior art devices of this general type, in which the frequency of the transmitting laser is varied to maximize the signal quality and, more specifically, the received power.

With the foregoing and other objects in view there is provided, in accordance with the invention, a method for setting a frequency of a transmitting laser in an optical transmission system. The method includes varying the frequency of the transmitting laser. The next step of the method is to measure the transmission quality of a data channel at a receiving end. The next step of the method is controlling the frequency of the transmitting laser such that an optimum transmission quality is achieved.

In accordance with a further object of the invention, the frequency of the transmitting laser can be varied experimentally by a controlling system.

In accordance with a further object of the invention, the method includes evaluating an associated received signal; and changing appropriately the frequency of the transmitting laser.

In accordance with a further object of the invention, the method includes sweeping the frequency of the transmitting laser. The period of a sweep voltage can be greater than one second.

In accordance with a further object of the invention, the controlling of the frequency of the transmitting laser is performed according to the lock-in principle.

In accordance with a further object of the invention, the method includes measuring the error rate of a received signal in a channelwise fashion, and determining a signal-to-noise ratio of the received signal as criterion for the transmission quality. The method also can include measuring the error rate of a received signal in a channelwise fashion, and determining a power of the received signal as criterion for the transmission quality. The method also can include measuring the error rate of a received signal in a channelwise fashion, and determining a power of a fundamental wave of the received signal, which is determined as quality criterion.

In accordance with a further object of the invention, the method includes transmitting measured values of the received power via a service channel to a controlling system arranged at a transmitting end.

In accordance with a further object of the invention, the method includes transmitting wavelength-division multiplex signals transmitted, and controlling each channel separately.

In accordance with the objects of the invention, the invention also includes a configuration for setting the frequency of a transmitting laser in an optical transmission system having a transmitting end and a receiving end. The configuration includes a first controlling system provided at the transmitting end varying experimentally a frequency of the transmitting laser. A power meter provided at the receiving end measures a power of the received signal. A service channel connects to the power meter. A controlling system at the receiving end receives measured values from the service channel. The controlling system measures the received measured values and varies the frequency of the transmitting laser to maximize the received power.

According to a further object of the invention, the configuration includes a second controlling system provided at the transmitting end having a sweep generator periodically varying the frequency of the transmitting laser, and a correlator generating a control signal. A power meter provided at the receiving end measures the power of the received signal to produce measured values. A service channel transmits the measured values from the power meter to the second controlling system. The second controlling system correlates the measured values with the sweep signal in order to generate the control signal that determines the frequency of the transmitting laser to maximize the measured values.

In accordance with a further object of the invention, the transmitting laser produces an amplitude-modulated signal which is multiplexed with a data signal to form a multiplex signal containing a plurality of channels. The controlling system maximizes the received power for each channel.

In accordance with a further object of the invention, the controlling system contains a Peltier element having a temperature. The controlling system controls the frequency of the transmitting laser by changing the temperature of the Peltier element.

In accordance with a further object of the invention, the method and configuration adapt the transmitter frequency optimally to the drift of the remaining transmission system.

The invention has the advantage that the frequency of the transmitting laser is controlled such that the transmission system has optimum transmission characteristics.

A particularly simple control is obtained when the transmitted power is intended to achieve a maximum value. This variant is, moreover, not a function of the data rate, and is therefore particularly advantageous. It is possible to use various control methods.

An optimum setting is ensured for each transmission channel by virtue of the fact that the measured values of each transmission channel are determined at the receiving end. A common control is also certainly possible in principle, but it could not compensate the various deviations in the transmission channels.

Control in accordance with the lock-in principle. In the lock-in principle, the frequency of the transmitting laser is varied with a sweep signal. The sweep signal is of low frequency by comparison with the transmitted data, is particularly easy.

Other features which are considered as characteristic for the invention are set forth in the appended claims.

Although the invention is illustrated and described herein as embodied in a method and configuration for setting the frequency of a transmitting laser, it is nevertheless not intended to be limited to the details shown, because various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a first configuration according to the invention.

FIG. 2 shows a second exemplary embodiment, with control according to the lock-in principle.

### DESCRIPTION OF THE PREFERRED EMBODIMENTS

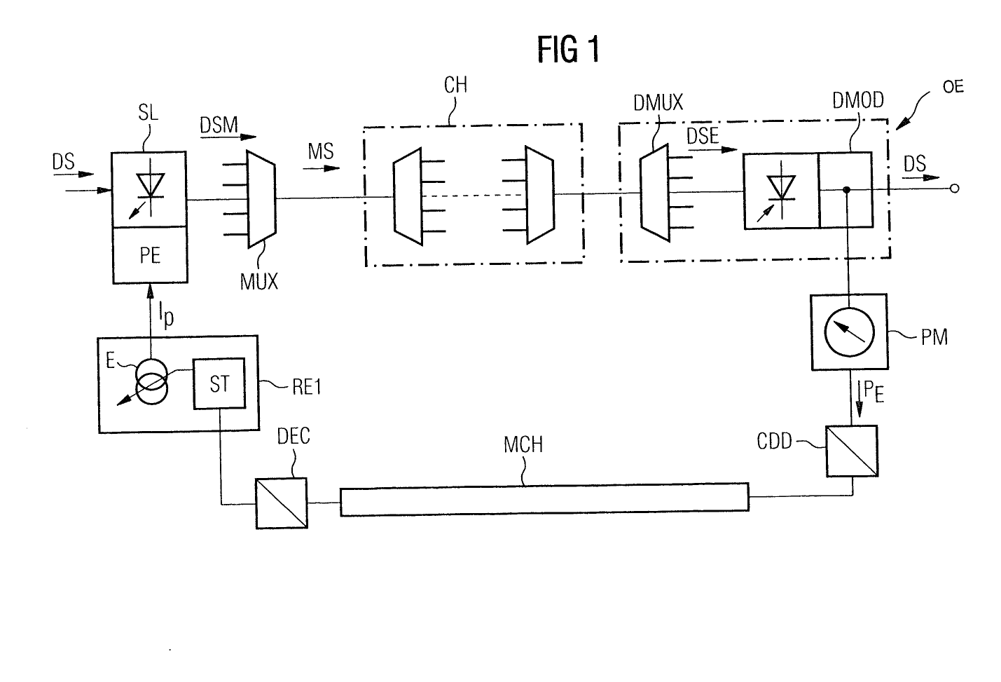

FIG. 1 shows a transmitting laser SL (or a laser with a downstream modulator), which is amplitude-modulated with a data signal DS. The modulated data signal DSM is combined with other signals by a multiplexer MUX to form a multiplex signal MS, and transmitted to an optical receiver OE via a transmission channel CH. In the optical receiver OE, the multiplex signal MS is split up again in a demultiplexer DMUX into individual signals which are converted separately into electric signals in a demodulator DMOD, an electrooptic transducer. It is, again, only the configuration for a received signal DSE that is illustrated. The transmission quality is evaluated for each data signal in each channel. This can be performed, for example, by measuring the error rate, the signal-to-noise ratio or the received power (or amplitude).

A power meter PM is used in the exemplary embodiment. A filter tuned to the transmission rate generally improves the evaluation. The measured values P_{E} can be fed in analog fashion—or converted into digital values by an encoder COD—to a first controlling system RE1 via a service back channel MCH and a decoder DEC. In the case of the embodiment described here, said controlling system sets the laser frequency such that the received power assumes a maximum value. This optimization is performed by varying the laser frequency with the aid of the controller ST of the first controlling system RE1 which uses a setting device E, here a current source, to change the current setting Iₚ of a Peltier element PE, and thus the temperature of the transmitting laser SL. As a result of which, the laser frequency is changed and then the change in power is determined on the basis of the measured values received via the back channel. If the setting has led to an increase in power, the new value of the current setting is regarded as a new desired value. Further changes are then undertaken until the power maximum is reached. It is likewise possible to undertake interpolations and extrapolations between several measured values.

The width of the variation in the current setting, and thus in the laser frequency, and the control time constant can be changed as a function of various operating states, or be made to depend on the power measured at the receiving end. In the case of WDM systems, parts of the control circuit can, of course, also be used jointly, or operate in time-division multiplex mode.

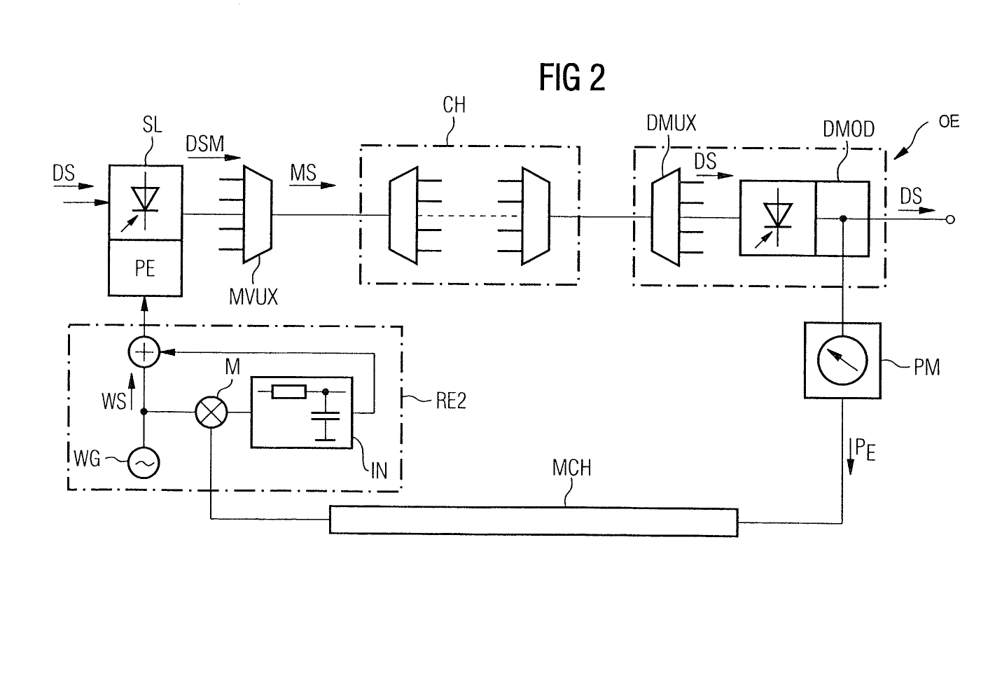

A second exemplary embodiment, illustrated in FIG. 2, uses a control circuit in accordance with the lock-in principle. The frequency of the transmitting laser SL is varied slowly with the aid of the control signal S_{RW} of a sweep generator WG, for example with a period of between ten and one-hundred seconds (10-100 sec.). The measured values P_{E} of the received power are fed via the service channel MCH to a correlator containing a multiplier M and an integrator IN. In the correlator, where the measured values PE are firstly multiplied by the sweep signal WS. If, for example, larger measured values P_{E} are produced in the case of a positive sweep voltage WS, the result is a positive control signal RS. This has the consequence that the Peltier element PE receives via an adder ADD, which is also fed the sweep signal WS, a control signal S_{RW} with a larger direct component (a larger current setting), as a result of which the current setting is changed until equilibrium ensues.

If the frequency setting is undertaken by changing the laser current setting, the amplitude of the transmitting laser is kept constant by a further control circuit (not illustrated). Because the method is used, in particular, for WDM transmission systems, despite separate control of each transmitting laser, it is possible for elements of the controlling system such as the sweep generator to be used jointly for all channels, and for other elements to operate in accordance with the time-division multiplex method.

We claim:

1. A method for setting a frequency of a transmitting laser in an optical transmission system, which comprises:
varying a frequency of a transmitting laser;
measuring a transmission quality of a data channel at a receiving end, and
controlling the frequency of the transmitting laser such that an optimum transmission quality is achieved.

2. The method according to claim 1, wherein the step of varying the frequency of the transmitting laser is carried out by varying experimentally by a controlling system.

3. The method according to claim 1, which further comprises:
evaluating an associated received signal; and
changing appropriately the frequency of the transmitting laser.

4. The method according to claim 1, which further comprises:
sweeping the frequency of the transmitting laser.

5. The method according to claim 1, wherein the step of controlling the frequency of the transmitting laser is performed according to the lock-in principle.

6. The method according to claim 1, which further comprises:
measuring an error rate of a received signal in a channelwise fashion, and
determining a signal-to-noise ratio of the received signal as a criterion for the transmission quality.

7. The method according to claim 6, which further comprises:
transmitting measured values of the received power via a service channel to a controlling system arranged at a transmitting end.

8. The method according to claim 1, which further comprises:
measuring an error rate of a received signal in a channelwise fashion, and
determining a power of the received signal as criterion for the transmission quality.

9. The method according to claim 8, which further comprises:
transmitting measured values of the received power via a service channel to a controlling system arranged at a transmitting end.

10. The method according to claim 1, which further comprises:
measuring an error rate of a received signal in a channelwise fashion, and
determining a power of a fundamental wave of the received signal, which is determined as a quality criterion.

11. The method according to claim 10, which further comprises:
transmitting measured values of the received power via a service channel to a controlling system arranged at a transmitting end.

12. The method according to claims 4, wherein a period of a sweep voltage is greater than one second.

13. The method according to claim 1, which further comprises:
transmitting wavelength-division multiplex signals, and
controlling each channel separately.

14. A configuration for setting the frequency of a transmitting laser in an optical transmission system having a transmitting end and a receiving end, the configuration comprising:
a controlling system provided at the transmitting end for experimentally varying a frequency of the transmitting laser,
a power meter provided at the receiving end measuring a power of the received signal,
a service channel connected to said power meter,
a controlling system at the receiving end receiving measured values from said service channel, said controlling system measuring said received measured values and varying the frequency of the transmitting laser to maximize the received power.

15. The configuration according to claim 14, including:
another controlling system provided at the transmitting end having a sweep generator periodically varying the frequency of the transmitting laser, and a correlator generating a control signal,
a power meter provided at the receiving end measuring the power of the received signal to produce measured values,
a service channel transmitting said measured values from said power meter to said other controlling system,
said second controlling system correlating said measured values with said sweep signal in order to generate the control signal that determines the frequency of the transmitting laser to maximize said measured values.

16. The configuration as claimed in claim 14, wherein the transmitting laser produces an amplitude-modulated signal multiplexed with a data signal to form a multiplex signal containing a plurality of channels, and said controlling system maximizing the received power for each channel.

17. The configuration as claimed in claim 14, wherein said controlling system contains a Peltier element having a temperature, and said controlling system controls the frequency of the transmitting laser by changing said temperature of said Peltier element.
